(19) United States
(12) Patent Application Publication
(10) Pub. No.: US 2022/0414087 A1
(43) Pub. Date: Dec. 29, 2022

(54) METHOD AND SYSTEM FOR GENERATING DIGITAL IDENTITY INFORMATION ON BLOCKCHAIN

(71) Applicant: Vesto LLC, Cheyenne, WY (US)

(72) Inventors: Christopher McGregor, Cheyenne, WY (US); Travs M. McGregor, Greenbrae, CA (US); Wolfgang Decker, Gruenwald (DE); Carsten Bartsch, Munich (DE)

(73) Assignee: Vesto LLC, Cheyenne, WY (US)

(21) Appl. No.: 17/355,934

(22) Filed: Jun. 23, 2021

(51) Int. Cl. G06F 16/23; G06Q 30/02

(52) U.S. Cl. CPC G06F 16/2379; G06Q 30/0201; G06Q 50/01

(57) ABSTRACT

A method and a system for generating an identity information on a blockchain database for a user is provided. User data associated with unique userID of the user is received via user device and stored on the blockchain database. A community score is determined and continually updated based on the received corresponding user data. The updated community score is validated against a set of predefined scores in percentage, ranging from 0 to 100%. The range of predefined scores includes values pertaining to negative, neutral and positive behavior of the user. The identity information for a user is generated based on the updated community score being validated within the range of values pertaining to the positive behavior of the user.

### FIELD OF THE DISCLOSURE

The present disclosure relates to digital identity solutions and more particularly to a method and a system for generating personal identity information of a user on a blockchain.

### BACKGROUND OF THE DISCLOSURE

Personal identity information has always played an important role in several aspects for any person. Generally, true information with respect to identity of a person, based on existing records and/or facts, is recorded by using various physical and/or digital documents by respective government authorities or authorized local organizations. Such recorded valid documents help in proving one's genuine identity during various verification processes that a person may be required to undertake for various purposes.

Due to lack of respective valid identity documents and legal identity status, many people, such as migrants, are unable to avail very basic and necessary facilities being provided by local authorities or government. For example, facilities like having bank accounts, bank loans, credit cards, voting registration, passports, driving licenses, vehicle registrations, cellphone connections, landline and broadband connections, that are regulated by a given government or authority or organization. Hence, people who do not have any valid identity documents, are unable to prevail equivalent benefits and services as compared to the individuals who have a legal status in their country and accordingly possess valid identification documents. In view of the above, there exist a need to allow all genuine and respectable individuals to have their valid personal identity documents that may be used as a government equivalent identification document for different purposes.

One solution of creating identity information for an individual is to implement digital identification systems wherein based on various activities and data transactions made by the individual via one or more digital/electronic devices, a unique identification (ID) of a person may be created. Such IDs typically contain personal information about the individuals and their relationships with other entities in the digital domain.

However, the implementation of digital identification systems to create a valid and unique ID of a person may not be useful or applicable at all instances. For example, getting a personal banking account and availing related facilities and benefits thereof, may be difficult for some individuals who do not have valid identification documents issued by the government or local authorities. This is due to the fact that almost every bank and financial organization may make mandatory for its customers to comply with the legal formalities of ‘Know Your Customer’ (KYC) and ‘Anti-money Laundering’ (AML) in order to identify its customers and also for preventing fraudulent transactions.

Further, the processes of KYC and AML regulations carried by the banks are quite time consuming and expensive. Further, many digital identity systems may not be secured and the digital IDs created by such digital systems may easily be duplicated or tampered.

The above-explained drawbacks may be addressed by secured digital identification systems based on blockchains and other types of distributed ledger technologies that are continually developing, especially in terms of residency-local government issued identification and identity management.

Blockchain identification systems are now being commercially used, and novel platforms are being deployed or explored for various registration processes for an individual, such as voting registrations, vehicle registrations etcetera. Smart contracting and wallets are also being continually developed, such as with improvements to signature cryptography, addition of metadata to increase provenance, and multi-signature wallet capabilities.

In view of the above, there exists a need to facilitate an individual to obtain a personal digital identity, that is secured and can be further used as an equivalent document/information to comply with the legal requirements, for various future purposes.

### SUMMARY OF THE DISCLOSURE

In order to provide a holistic solution in the field of digital identity management, it is necessary to globally provide to all the people, a facility to generate digital identification information that can be used in equivalence to the government authorized identification documents. The present disclosure discloses the usage of Blockchain technologies in collecting user data and subsequently generating valid identification information on a blockchain.

An object of this disclosure is to facilitate generation of digital identities (ID) on a blockchain database for users.

Another object of this disclosure is to provide identification metrics to the population that does not have a government identification to pass KYC and AML, verification standards for availing facilities and benefits from various organizations and institutions.

Another object of this disclosure is to deploy blockchain database(s), multiple-signature wallet smart-contracts, digital affidavits, biomarkers, smartphone feature utilization, and good standing societal criteria watch list and data analytics checking, in order to generate unique digital identification for respective user.

Another object of this disclosure is to solve the existing drawbacks of delayed and expensive processes of KYC and AML verification processes by generating digital identities for the users in accurate and faster manner.

Another object of this disclosure is to facilitate good standing people from all over the world to obtain a authentic digital identification for their respective country.

According to an embodiment, there is provided a method for generating an identity information on a blockchain database for a user. The method comprising: configuring at least one user device for identifying a unique userID with respect to the user, wherein the user device is having a processing unit, a display screen and a memory; storing one or more predefined categories and associated factors on a server; receiving user data with respect to one or more predefined categories and associated factors, the user data corresponds to the unique userID and is received via the at least one user device; storing the user data along with the corresponding unique userID on the blockchain database; assigning a community score to the user, the community score being determined based on the received corresponding user data; continually updating the community score upon receiving any update in the user data; validating the updated community score against a range of predefined scores from 0 to 100%, the range of predefined scores includes values pertaining to negative, neutral and positive behavior of the user; and generating the identity information based on the updated community score being validated within the range of values pertaining to the positive behavior of the user.

In an embodiment, the user data is based on categories including at least one of: a social profile of the user; a financial profile of the user; and a biometric profile of the user.

In an embodiment, the factors associated with the one or more categories include, but are not limited to, finance related factors, GPS location related factors, social factors, and biometric factors.

In an embodiment, the received user data is based on habitual pattern and behavioral aspects being recorded from daily life of the respective user.

In an embodiment, the user data includes, but is not limited to, user bank account details; purchasing habit of the user; payment history; current GPS location of the user; user's commuting time to office and commuting route; contact details of friends, colleagues, relatives and acquaintances of the user; social interaction pattern of the user; community vouching; and user's biometric data.

In an embodiment, based on the received user data with respect to each of the one or more categories and associated factors, a weight value is assigned. The one or more assigned weight values are aggregated to determine the community score.

In an embodiment, the social profile of the user is based on at least GPS data extracted from the corresponding user device, and a watchlist of societal criteria associated with the user.

In an embodiment, the financial profile of the user is based on a financial and cryptocurrency transactions made by the user.

In an embodiment, the biometric profile of the user is based on at least personal biometric data of the user.

In an embodiment, the method includes identifying and removing any duplicate identities of the user.

In an embodiment, the unique userID is based on a unique blockchain crypto address that is generated automatically.

In an embodiment, a system is provided for generating an identity information on a blockchain database for a user. The system comprises: the blockchain database; an identity information generating module in communication with at least one processing unit and one storage unit in a communication network, the identity information generating module configured to: identify a unique userID with respect to the user using a user device, the user device having a processing unit, a display screen and a memory; storing one or more predefined categories and associated factors on the storage unit; receive, via the at least one user device, user data with respect to one or more predefined categories and associated factors, the user data corresponds to the unique userID and is received via the at least one user device; store the unique userID along with the corresponding user data on the blockchain database; assign a community score to the user, the community score being determined based on the received corresponding user data; continually update the community score upon receiving updated user data; validate the updated community score against a range predefined scores from 0 to 100%, the range of predefined scores including values pertaining to negative, neutral and positive behavior of the user; and generate the identity information based on the updated community score being validated within the range of values pertaining to positive behavior of the user.

The aforementioned objectives and additional aspects of the embodiments herein will be better understood when read in conjunction with the following description and accompanying drawings. It should be understood, however, that the following descriptions, while indicating preferred embodiments and numerous specific details thereof, are given by way of illustration and not of limitation. This section is intended only to introduce certain objects and aspects of the present disclosure, and is therefore, not intended to define key features or scope of the subject matter of the present disclosure.

### BRIEF DESCRIPTION OF THE DRAWINGS

The figures mentioned in this section are intended to disclose exemplary embodiments of the claimed system and method. Further, the components/modules and steps of a process are assigned reference numerals that are used throughout the description to indicate the respective components and steps. Other objects, features, and advantages will be apparent from the following description when read with reference to the accompanying drawings.

FIG. 1 is a block diagram of system for generating an identity information on a blockchain database.

FIG. 2 is a block diagram illustrating the structural and functional elements of identity information generating module.

FIG. 3a illustrates types of predefined categories and associated factors used for determining a community score for a user.

FIG. 3b illustrates statistical aggregation of various values based on data pertaining to different categories for determining a partial community score.

FIG. 3c illustrates aggregation of various values based on data pertaining to different categories for determining a total community score.

FIG. 4 illustrates a method for generating an identity information on a blockchain database, according to an exemplary embodiment.

Like reference numerals refer to like parts throughout the description of several views of the drawings.

### DETAILED DESCRIPTION OF THE DISCLOSURE

This section is intended to provide explanation and description of various possible embodiments of the present disclosure. The embodiments used herein, and various features and advantageous details thereof are explained more fully with reference to non-limiting embodiments illustrated in the accompanying drawings and detailed in the following description. The examples used herein are intended only to facilitate an understanding of ways in which the embodiments herein may be practiced and to further enable the person skilled in the art to practice the embodiments used herein. Also, the examples/embodiments described herein should not be construed as limiting the scope of the embodiments herein. Corresponding reference numerals indicate corresponding parts throughout the drawings.

The present disclosure relates to a system and a method for generating an identity information on a blockchain database for a user. User data associated with unique userID of an individual user may be received and stored on the blockchain database. A community score for the respective individual may be determined based on the received corresponding user data. The community score may be continually updated based on any updated data received with respect to the user. The updated community score may be further validated against a set of predefined scores in percentage, ranging from 0 to 100%. The range of predefined scores includes values pertaining to negative, neutral and positive behavior of the user. The identity information for a user is generated digitally, based on the updated community score being validated within the range of values pertaining to the positive behavior of the user.

As used herein, ‘user device’ is a smart electronic device capable of communicating with various other electronic devices and applications via one or more communication networks. Examples of the user device include, but not limited to, a wireless communication device, a smart phone, a tablet, a desktop, etc. The user device comprises: an input unit to receive one or more input data; an operating system to enable the user device to operate; a processor to process various data and information; a memory unit to store initial data, intermediary data and final data; and an output unit.

As used herein, the user data refers to data and information pertaining to a social profile, a financial profile and a biometric profile of a user or an individual.

As used herein, a blockchain refers to, a distributed database that facilitates in establishing and maintaining a continuously increasing records of secured data transactions. The data stored on a blockchain may be secured by cryptography.

As used herein, ‘userID’ refers to a unique identifier associated with a corresponding user or individual. The userID may include alphanumeric usernames, words, numbers, symbols, and may be used to identify a particular user in the process of generating respective digital identity.

As used herein, ‘module’ or ‘unit’ refers to a device, a system, a hardware, a computer application configured to execute specific functions or instructions according to the embodiments of the present disclosure. The module or unit may include a single device or multiple devices configured to perform specific functions according to the present disclosure disclosed herein.

As used herein, ‘processing unit’ is an intelligent device or module, that is capable of processing digital logics and also possesses analytical skills for analyzing and processing various metadata and user related data or information, according to the embodiments of the present disclosure. The processing unit may also refer to any computer processing unit comprising, but not limited to, a single-core processor, a multi-core processor.

As used herein, ‘storage unit’ or ‘database’ refers to a local or remote memory device or a database capable to store user metadata, predefined categories, statistical data pertaining to various categories and associated factors, partial community scores, final community scores. In an embodiment, the storage unit may be a database server, a cloud storage, a remote database, a local database.

As used herein, ‘network’ refers to a communication network including but not limited to a local area network (LAN), a wide area network (WAN), a metropolitan area network (MAN), a virtual private network (VPN), an enterprise private network (EPN), Internet, and a global area network (GAN).

Terms such as ‘connect’, ‘couple’ and other similar terms include a physical connection, a wired connection, a wireless connection, a logical connection or a combination of such connections including electrical, optical, RF, infrared, Bluetooth or other transmission media, as may be obvious to a person skilled in the art.

Terms such as ‘send’, ‘transfer’, ‘transmit’ and ‘receive’, ‘collect’, ‘obtain’ and other similar terms refers to transactions of data between various modules and units via wired or wireless connections.

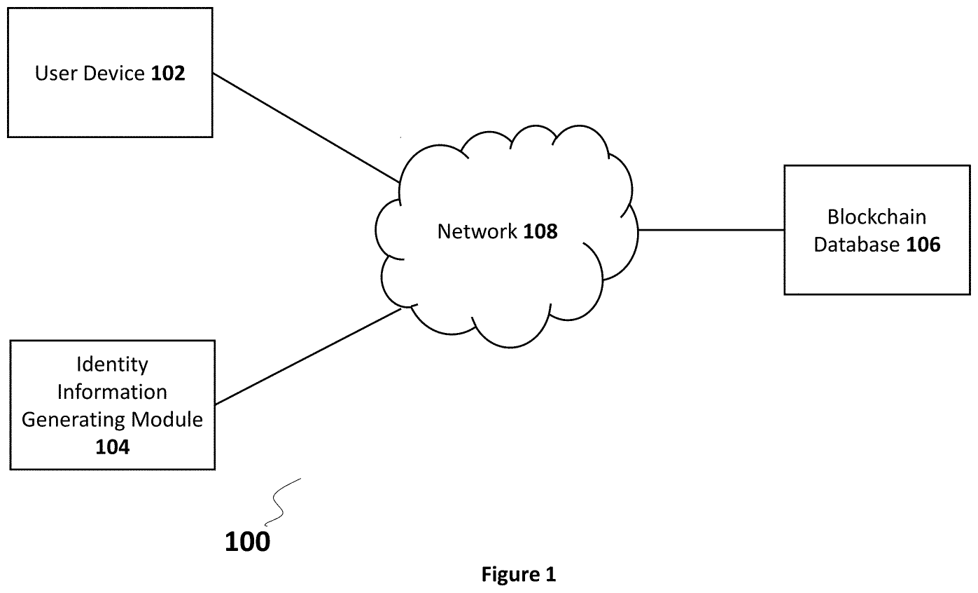

FIG. 1 illustrates a system 100 for generating an identity information on a blockchain database for a user. The system 100 comprises a user device 102, an identity information generating module 104, and a blockchain database 106 communicably connected to each other via a communication network 108.

In one embodiment herein, the blockchain database 106 and user device 102 are in communication with the identity information generating module 104 across the communication network 108, to facilitate the transactions of data pertaining to digital identification information generation. The identity information generating module 104 may be configured to communicate with at least one processing unit 214 for performing the function of digital identification generation. The user data may be received by the identity information generating module 104 via the user device 102 across the network 108. The processing unit 214 may be configured to process the received user data pertaining to personal, professional and social information about the user or an individual. The user device 102 may have a processor, a user interface, a memory and one or more applications being executed on the user device 102 to provide support in the processes of identity information generation, according to the embodiments disclosed herein. Initially, the identity information generating module 104 identifies a unique userID associated with a corresponding user device 102 of the respective user. The unique ID for each user or the individual is based on a unique blockchain crypto address that is automatically generated. In an embodiment, the unique userID with respect to a user may be generated automatically by the system 100. In another embodiment, the unique userID with respect to a user may be generated by an external organization, authorized institutions, systems or by the users themselves. Such externally generated userIDs may be extracted or received by the system 100 from the user device 102.

The identity information generating module 104 stores one or more predefined categories and associated factors on a server. The identity information generating module 104 receives user data with respect to one or more predefined categories and associated factors. As mentioned above, the user data corresponds to the respective unique userID and may be received via the at least one user device 102 in respect to a given predefined category. The user data along with the corresponding unique userID may be securely stored on the blockchain database. The identity information generating module 104 is further configured to determine for the respective user, a community score based on the received corresponding user data. The community score is determined by using evaluation function algorithm for assigning weight values against the received user data in respect of various categories and factors. Thereafter, all the weight values are aggregated to determine the community score. According to the embodiments of the present disclosure, the community score is normalized to the range of predefined scores of 0-100% range for identifying whether the community score of the user corresponds to a positive value, a neutral value or a negative value with respect to a specific category.

According to the embodiments of the disclosure, the user data may be either be collected manually and inputted manually in the digital identity determination module, or can be received via the user device 102. The user data may be continuously received by the identity information generation module 104 for over a period of time. Such period of time may be predefined and stored within the system 100 for each user or individual. During the initial period of receiving or collecting user data, a temporary/partial community score may be generated for a respective user based on various predefined categories and factors. The period of time may be defined in hours, days, weeks, months or years, and may vary based on different predefined categories and factors. For instance, to determine whether a person is having a stable job or earning, the professional profile of the user may be monitored. In this aspect, GPS data pertaining to daily route and time taken by the user to commute to user's office/work place may be monitored for the period as predefined, e.g., 4 weeks. Said GPS data obtained daily during the set number of weeks or months may be used as the ‘user data’ with respect to that category (‘professional profile’ category in this case). The predefined period of time may also vary depending upon the type of the user. For example, a user having good societal standing may be required to be monitored for a lesser period of time than the user who does not possess good societal standing, or any documentary evidence in his favour. In another example, a person having history of positive behavior and who has not committed any frauds or any other illegal activities, may be required to be monitored for a lesser period of time as compared to the person having non-positive behavioral pattern or wrongful history.

The user data received or collected over a predefined period of time may be used to determine the partial community score for the user in a particular category and its associated factors. The processing of user data to determine the partial community score is a continuous process during the predefined period of time. Accordingly, the partial community score may continuously be determined based on the continuous processing of the received user data. The partial community score may likewise be continually updated in the event if there is any change or further addition in the corresponding user data in the respective category.

Further, the temporary/partial community score, as being determined, may be assigned to the respective users at an instant. The identity information generating module 104 continuously monitors various factors in the respective categories to identify if there is any update in the corresponding user data as received. Accordingly, the partial community scores may be aggregated to determine the final/updated community score. The updated community score is therefore an aggregation of continuous update in the partial community score to calculate the final or total community score. The final community score may be assigned to the user based on which the identity information generating module 104 may generate a digital identity of the respective user.

The identity information generating module 104 may further be configured to validate the updated community score against a range of predefined percentage scores starting from 0% up to 100%. The range of predefined percentage scores may include values pertaining to negative, neutral and positive behavior of the user. According to the embodiments of the present disclosure, behavioral data may be extracted by analyzing various types of behavior of the user with respect to a category and associated factors. The behavioral data of the user may be classified into positive behavior, negative behavior or neutral behavior. Thereafter, using the evaluation function algorithm, and depending upon the behavioral data with respect to a category and associated factors, the positive, negative or neutral weight values may be assigned to the respective user. Finally, the identity information generating module 104 may generate the identity information based on the updated community score being validated within the range of values or weights pertaining to positive behavior of the user.

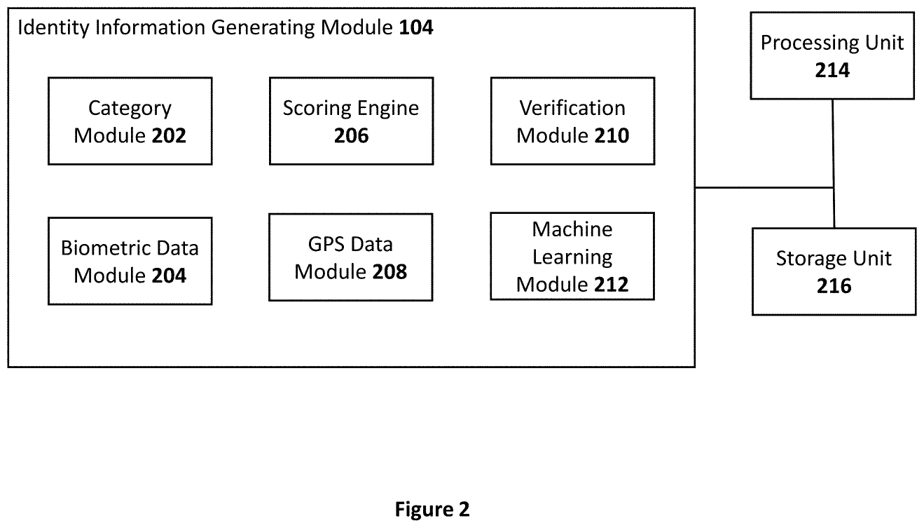

FIG. 2 is a block diagram illustrating the structural and functional elements of identity information generating module 104, according to an exemplary embodiment. The identity information generating module 104 comprises a category module 202, a scoring engine 206, a machine learning module 212, a biometric data module 204, a GPS data module 208, and a verification module 212. The identity information generating module 104 may be connected with a processing unit 214 and a memory or storage unit 216 that facilitates in data processing and data storage with respect to the functioning of identity information generating module 104. In one embodiment, the processing unit 214 and the storage unit 216 may be integrated with the identity information generating module 104. In another embodiment, the processing unit 214 and the storage unit 216 may be externally connected to the identity information generating module 104.

The category module 202 may be configured to provide various predefined categories and factors based on which the scoring engine 206 determines and aggregates various community scores to be assigned to respective users. The predefined categories may include at least one of a social profile of the user, a financial profile of the user, and a biometric profile of the user. The social profile of the user may be built by collecting information and data or metadata pertaining to personal life, social life, social personality and related activities of the user. The financial profile of the user may be created by collecting information and data or metadata pertaining to professional life, financial transactions, account balance, purchasing habits, salary and earnings, and related activities of the user. Similarly, the biometric profile of the user may be created by collecting information and data or metadata pertaining to biometric data such as fingerprints, iris scan, voice texture, voice pattern, typing speed while using the user device 102, gait, and any other unique physical and biological characteristics of the user.

According to the embodiments of the present disclosure, habitual or behavioral data, historical data and information pertaining to the above-mentioned social, financial and biometric categories, are collected or received from the day-to-day life of the user via the user device 102. For example, to collect information relating to personal/social profile of the users, various factors including daily wake-up time, daily sleeping time, frequency of visits to any particular place, office commuting time and commuting route over a period of time, contact details of friends, neighbors, relatives, or other people in proximity etcetera may be considered and predefined in the category module 202. The habitual and behavioral pattern of the user with respect to the predefined categories and factors may be collected and recorded over the predefined period of time, as explained earlier. The collected user data may be sent for further analysis and evaluated for calculating the community scores. In one embodiment, the scoring engine 206 is configured to assign various scores with respect to the user data received. The category module 202 may further be configured to receive user data from friends, neighbors, relatives, or other people in proximity of the user via respective user devices 102. Such neighbors, friends or relatives may be reputed members of a society or high community scorers of the society, who may have respectable societal standing and who can vouch for the positive behavior of the user. The community vouching feature provided in the embodiments of the present disclosure, enables the user to gain a positive or high score with respect to a category. For example, at regular intervals, the high community scorers may provide various survey data with respect to positive or negative behavior of the user, including work-life, personal life, social interactions, purchasing habits, ongoing debts, lawful or unlawful activities, that may in turn contribute as a positive or negative parameter for the user. The same may eventually be implemented in determining the overall community score aggregated for the user.

The biometric data module 204 is configured to generate unique biometric profile of the users, wherein a plurality of bio-markers may be recorded. The bio-markers may be recorded by extracting various biometric data from various biometric sensing devices or existing biometric data stored with any device associated with the user. The various biometric devices may include but are not limited to fingerprint scanning devices; iris scanning devices; camera devices; laptops, tablets and mobile phones that have in-built biometric sensing devices and applications etcetera. The biometric profile of the user may be created by collecting information and data or metadata pertaining to biometric data such as fingerprints, iris scan, voice pattern or voice recognition data, selfies and photographs, photo and video IDs, typing speed while using the user device 102, gait, facial biometric data, and any other unique physical and biological characteristics of the user. The biometric data and behavioral patterns of each user are uniquely different and cannot be mimicked by another person. For example, a personal mobile phone of one user may sometimes be carried or used by another user, however, the behavioral and habitual pattern of using the same phone by the two users will be different and subsequently, the collected user data will not match. The biometric profile of each user therefore provides a unique non-copyable identifier that ensures that the digital identity being generated for each of the user is genuinely originating from one person, and cannot be duplicated by any other person.

In one embodiment, the biometric data module 204 generates the biometric profile of the user in real time. Said biometric profile of the user may be updated periodically or over a period of time based on any updated biomarkers or additional biometric data received from the user device 102. The biometric data may be collected using various biometric devices such as camera devices, finger print sensors, iris scanning devices etcetera. Various biometric software applications may also be configured for recording the biometric data.

The scoring engine 206 is configured to perform evaluation function algorithm to calculate or determine the community score for each user. To calculate the score, the various factors which associated with the predefined categories, are separately assigned weight values against the user data as received. The weighted values are thereafter aggregated to determine an overall community score. The community score is normalized to the range of predefined scores of 0-100% for identifying whether the community score of the user, as determined, corresponds to a positive value, a neutral value, or a negative value with respect to a specific category.

The scoring engine 206 is further configured to update the community scores periodically. For each and every scoring factor, positive, neutral and negative behavior of the user is identified. The positive and negative values with respect to given factors, are included into an updated calculation of the aggregated community score. Neutral values are not included in order to filter any noise, or redundant data out. Initially, the community scores are to be updated with high frequency, for example on a daily or weekly basis. Once the factors affecting the community scores becomes stable, and fluctuates only little, lower frequency update cycles may be implemented.

The GPS (Global Positioning System) data module 208 is configured to monitor GPS activity of the user and accordingly receive the GPS data via the user device 102. The GPS data includes the location of the user in real-time, location of the user captured over a period of time, location of the user captured at regular intervals, or historical patterns of location data of the user. In one embodiment, the GPS data module 208, records or extracts the current location of the user devices 102 having in-built location identifier. When the user follows a route, or enters or exits any premises, a location data from the user device 102 may be read and recorded by the GPS data module 208. The GPS data module 208 may also be configured to capture, via the user device 102 or via any other GPS enabled application, the various commuting routes of the user to various places like office, workplace, home, market place, shopping malls, clubs or any other place where the user keeps visiting on regular intervals or on a daily basis. Such data may be implemented to score positive or negative weight values while determining the community scores. For example, a consistent commuting route to workplace may indicate that the user has a stable job and receives regular salary or remuneration. The GPS data module 208 may also record the location of other people with whom the user meets on a regular basis, to identify if the user is having connections with respectable/non-respectable people. This ultimately affects the score of the user. A user having acquaintance with noble people or good friend circle, will score positive weight values. On the other hand, any user having acquaintance with people with unlawful background may not be able to score positive weight values against one or more categories and associated factors. Further, GPS data module 208 may also record the location where the user makes any financial transaction. Such data may also be used while determining the community score for the user. Expenses carried out for daily essentials and necessary items may be considered for a positive score. On the other hand, unnecessary huge expenses made by the user very frequently, may be considered for a negative score.

The verification module 210 is configured to perform verification of various data as collected and generated by the system 100. The verification module may also be configured to verify multiple-signature wallet identities, digital affidavits, biomarkers, and societal criteria watch list in order to generate unique digital identification for respective user. The unique ID for each user or the individual may also be verified to ensure secure data transaction while generating the digital identity for respective users. Further, any partial and overall community score may be analysed by the verification module to validate the score against a set of predefined scores of 0 to 100% range. As described earlier, the range of predefined scores includes values pertaining to negative, neutral and positive behavior of the user. The identity information for a user is generated based on the updated community score being validated within the range of values pertaining to the positive behavior of the user. Further, the verification module in communication with the biometric module and GPS data module 208, may facilitate in identifying the duplicate or parallel identities or userIDs of the user.

In one embodiment, the verification module 210 is also configured to verify and match the user data received from a user, with data collected from other users. For example, user data, e.g., GPS location, received from one user who is an employee of an organization, may be matched and verified from the data (GPS location) collected from another user such as any employee or manager working in the same organization, or the owner of the organization. The verification module 210 may thus analyse the GPS location data to verify whether or not, the user has got a stable job in that organization. In another embodiment, the verification module 210 may also conduct a survey to receive a plurality of data from different users in order to verify the correctness of the user data received from the user via the user devices.

In one embodiment, the verification module 210 is also configured to identify whether or not a user possesses any valid identification documents issued by respective government organization or local authorities.

The machine learning module 212 is configured to analyse the received user GPS data, biometric data, historical data over a period of time. Based on the analysis of data over a period of time, the machine learning module 212 is capable of predicting the data with respect to a category and associated factors for a user. With the features of machine learning data, the factors affecting the scores of a user may be stabilized and accordingly fewer update cycles may be implemented to calculate the overall community score for the respective user. The machine learning module 212 may also be configured to constantly improve the scoring functions.

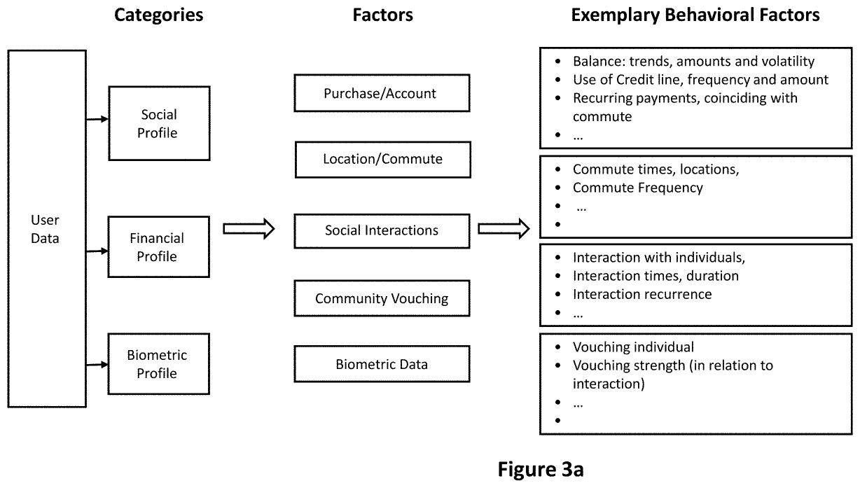

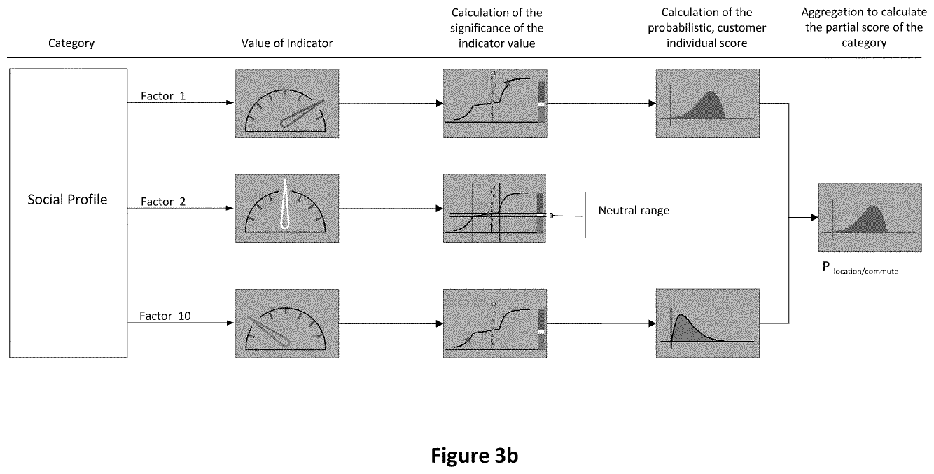

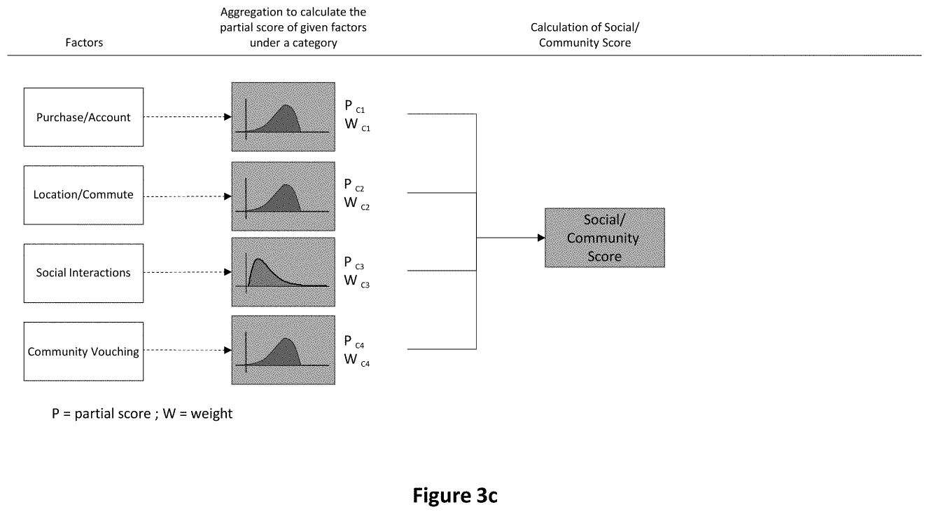

FIG. 3a illustrates types of categories and associated factors used for determining an aggregated community score for a user, according to an exemplary embodiment. As described above, the categories and associated factors are predefined in the system 100. Data from a user may be continuously received for over a period of time. The community score may be generated or evaluated for a respective user based on various predefined categories and factors. FIG. 3a-3c shows various categories and associated factors based on which the user data is recorded or collected. The one or more pre-defined categories include a social profile of the user; a financial profile of the user; and a biometric profile of the user. The factors associated with the one or more categories include, but is not limited to, finance related factors, such as accounts and purchase; GPS location related factors, such as location, commuting route, commuting time; social factors, such as social interaction with other users, community vouching; and biometric data factors.

As illustrated in FIG. 3a, the behavioral factors such as account balance, purchasing trends, credit status, recurring payment types, commuting time, location and commuting frequency, duration of interactions made by a user, interaction timings, interaction recurrences, etcetera may be used to assign the weight values in respect of a given category. For instance, to determine whether a person is having a stable job or earning, the category ‘professional profile’ of the user may be considered. In this aspect, GPS data pertaining to daily route and time taken by the user to commute to user's office/work place may be monitored for some days, e.g., 4 weeks. Said GPS data obtained daily during the set number of weeks or months may be used as the ‘user data’ with respect to that category (‘professional profile’ category in this case).

As illustrated in FIG. 3b, the user data received or collected in respect to a category and associated factors over a predefined period of time, may be assigned the corresponding weight values. The assigned weight values may indicate positive, neutral or negative behavior of the user. Various weight values may be used to determine the partial community score for the user in the category and its associated factors. The partial community score may be updated in the event if there is any change or further addition in the corresponding user data in the respective category.

FIG. 3c illustrates aggregation of various scores based on data pertaining to different categories for determining a total community score according to an exemplary embodiment. As illustrated in the figure and also described earlier, the temporary/partial community score, may be assigned to the respective users. Thereafter, the partial community scores may be aggregated to determine the final/updated community score. The updated community score is therefore an aggregation of continuous update in the partial community score to calculate the final or total community score. The final community score may be assigned to the user based on which the digital identity information of the respective user is generated.

Each of the determined community scores based on the predefined categories and associated factors may be stored within the storage units and databases as described with respect to embodiments of the present disclosure. The community scores are verified and implemented in generating the digital identity information of the user. The generated digital identity information may be implemented in future identity verification processes by the user.

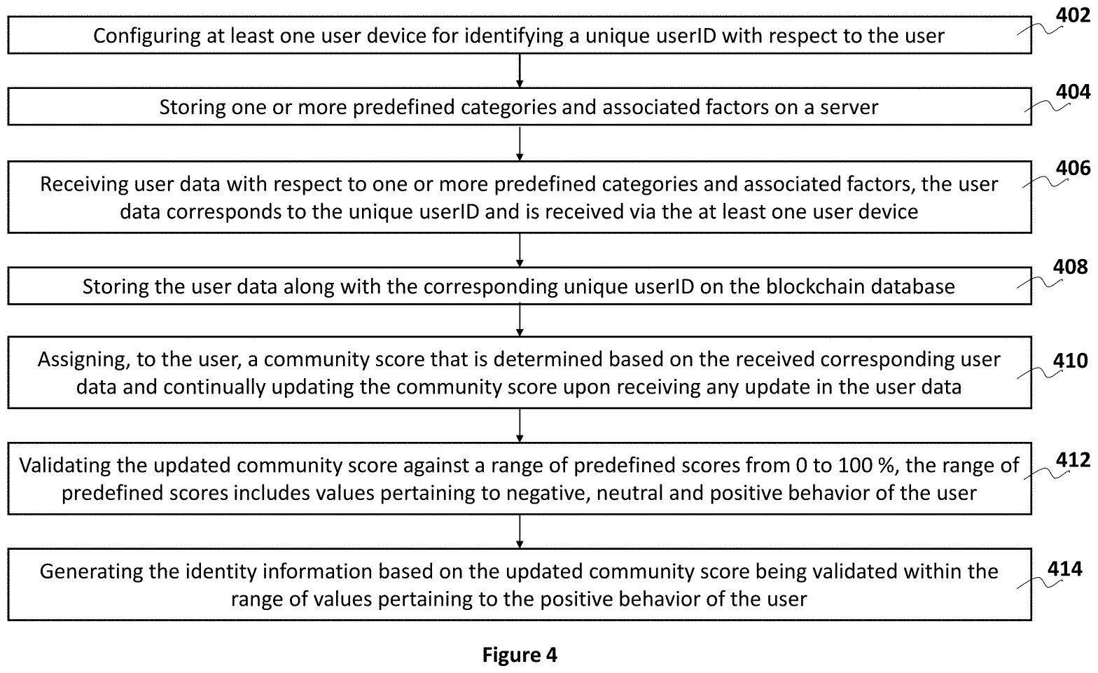

FIG. 4 illustrates a method for generating an identity information on a blockchain database, according to an exemplary embodiment.

At step 402, at least one user device 102 is configured for identifying a unique userID with respect to the user. The user device 102 comprises a processing unit 214, a display screen and a memory. Further, the user device 102 is in communication with the identity information generating module 104 and the blockchain database across the communication network 108, to facilitate the transactions of data pertaining to digital identification information generation.

At step 404, one or more predefined categories and associated factors are stored on the server. The predefined categories include at least one of a social profile of the user, a financial profile of the user, and a biometric profile of the user. The factors associated with the one or more categories include, but is not limited to, finance related factors, such as accounts and purchase; GPS location related factors, such as location, commuting route, commuting time; social factors, such as social interaction with other users, community vouching; and biometric data factors. Further, the social profile of the user is based on at least GPS data extracted from the corresponding user device 102, and a watchlist of societal criteria associated with the user. The financial profile of the user is based on a financial and cryptocurrency transactions made by the user. The biometric profile of the user is based on at least personal user's biometric data collected by using various biometric devices, biometric sensors, and biometric applications.

At step 406, user data is received or collected with respect to one or more predefined categories and associated factors, wherein the received user data is based on habitual pattern and behavioral aspects being recorded from daily life of the respective user. The user data corresponds to the unique userID and is received via the at least one user device 102. The user data may be manually collected and recorded in the database. The user data may also be received via the user device 102 and may include, user bank account details; purchasing habit of the user; payment history; current GPS location of the user; user's commuting time to office and commuting route; contact details of friends, colleagues, relatives and acquaintances of the user; social interaction pattern of the user; community vouching; user's biometric data and any other user's activities related data. Based on the received user data with respect to each of the one or more predefined categories and associated factors, a weight value is assigned.

At step 408, the user data along with the corresponding unique userID is stored on the blockchain database. The unique userID is based on a unique blockchain crypto address that is generated automatically. According to the embodiments of the present disclosure, any duplicate identities of the user or userIDs are identified and removed from the database in order to avoid data redundancy.

At step 410, community score may be assigned to the user. The community score is determined based on the received corresponding user data. The community score is continuously being updated upon receiving any update in the user data.

At step 412, the updated community score is validated against a range of predefined scores from 0 to 100%, the range of predefined scores includes values pertaining to negative, neutral and positive behavior of the user.

At step 414, the identity information is generated based on the updated community score being validated within the range of values pertaining to the positive behavior of the user.

Thus, the present disclosure provides for methods and systems for generating personal identity information of a user on a blockchain and thereby facilitating the people to generate personal digital identification information in a fast and accurate manner. Said identity information can be used in equivalence to the government authorized identification documents.

The embodiments as described above, facilitate in providing identification metrics to the people who do not have a government identification to pass KYC and AML verification standards in order to avail facilities and benefits from various organizations and institutions. The embodiments as described above, also facilitate in deploying blockchain database(s), multiple-signature wallet smart-contracts, digital affidavits, biomarkers, smartphone feature utilization, and good standing societal criteria watch list and data analytics checking, for generating unique digital identification for respective user.

The term exemplary is used herein to mean serving as an example. Any embodiment or implementation described as exemplary is not necessarily to be construed as preferred or advantageous over other embodiments or implementations. Further, the use of terms such as including, comprising, having, containing and variations thereof, is meant to encompass the items/components/process listed thereafter and equivalents thereof as well as additional items/components/process.

It will be apparent that various aspects may be implemented as a software and hardware (such as a processing unit) in the implementations illustrated in the figures. Additionally, it should be appreciated that according to one aspect of this embodiment, one or more computer programs that when executed perform methods need not reside on a single computer or processor but may be distributed in a modular fashion amongst a number of different computers or processors to implement various aspects of the present disclosure.

Although the subject matter is described in language specific to structural features and/or acts, it is to be understood that the subject matter defined in the claims is not necessarily limited to the specific features or process as described above. In fact, the specific features and acts described above are disclosed as mere examples of implementing the claims and other equivalent features and processes which are intended to be within the scope of the claims.

What is claimed is:

1. A method for generating an identity information on a blockchain database for a user, the method comprising:
configuring at least one user device to identify a unique userID with respect to the user, wherein the user device comprises a processing unit, a display screen, and a memory;
storing one or more predefined categories and associated factors on a storage unit;
receiving a user data with respect to one or more predefined categories and associated factors, the user data corresponds to the unique userID and is received via the at least one user device;
storing the user data along with the corresponding unique userID on the blockchain database;
assigning a community score to the user, the community score being determined based on the received corresponding user data;
continually updating the community score upon receiving any update in the user data;
validating the updated community score against a range of predefined scores from 0 to 100%, the range of predefined scores includes values pertaining to negative, neutral and positive behavior of the user; and
generating the identity information based on the updated community score being validated within the range of values pertaining to the positive behavior of the user.

2. The method as claimed in claim 1, wherein the one or more categories include at least one of:
a social profile of the user;
a financial profile of the user; and
a biometric profile of the user.

3. The method as claimed in claim 2, the social profile of the user is based on at least GPS data extracted from the corresponding user device, and a watchlist of societal criteria associated with the user.

4. The method as claimed in claim 2, the financial profile of the user is based on a financial and cryptocurrency transactions made by the user.

5. The method as claimed in claim 2, the biometric profile of the user is based on at least personal biometric data of the user.

6. The method as claimed in claim 1, wherein the factors associated with the one or more categories comprises one or more of finance related factors, GPS location related factors; social factors; and biometric factors.

7. The method as claimed in claim 1, wherein the received user data is based on habitual pattern and behavioral aspects being recorded from daily life of the respective user.

8. The method as claimed in claim 1, wherein the user data comprises one or more of user bank account details; purchasing habit of the user; payment history; current GPS location of the user; user's commuting time to office and commuting route; contact details of friends, colleagues, relatives and acquaintances of the user; social interaction pattern of the user; community vouching; and user's biometric data.

9. The method as claimed in claim 1, wherein based on the received user data with respect to each of the one or more categories and associated factors, a weight value is assigned.

10. The method as claimed in claim 9, wherein one or more assigned weight values are aggregated to determine the community score.

11. The method as claimed in claim 1, further comprising identifying and removing any duplicate identities of the user.

12. The method as claimed in claim 1, wherein the unique userID is based on a unique blockchain crypto address generated automatically.

13. A system for generating an identity information on a blockchain database for a user, the system comprising:
the blockchain database; and
an identity information generating module in communication with at least one processing unit and one storage unit in a communication network, the identity information generating module configured to:
identify a unique userID with respect to the user using a user device, the user device having a processing unit, a display screen and a memory;
storing one or more predefined categories and associated factors on the storage unit;
receive, via the at least one user device, a user data with respect to one or more predefined categories and associated factors, the user data corresponds to the unique userID and is received via the at least one user device;
store the unique userID along with the corresponding user data on the blockchain database;
assign a community score to the user, the community score being determined based on the received corresponding user data;
continually update the community score upon receiving updated user data;
validate the updated community score against a range predefined scores from 0 to 100%, the range of predefined scores including values pertaining to negative, neutral and positive behavior of the user;
generate the identity information based on the updated community score being validated within the range of values pertaining to positive behavior of the user.

14. The system as claimed in claim 13, wherein the one or more categories include at least one of:
a social profile of the user;
a financial profile of the user; and
a biometric profile of the user.

15. The system as claimed in claim 14, the social profile of the user is based on at least GPS data extracted from the corresponding user device, and a watchlist of societal criteria associated with the user.

16. The system as claimed in claim 14, the financial profile of the user is based on a financial and cryptocurrency transactions made by the user.

17. The system as claimed in claim 14, the biometric profile of the user is based on at least personal biometric data of the user.

18. The system as claimed in claim 13, wherein wherein the factors associated with the one or more categories comprises one or more of finance related factors, GPS location related factors; social factors; and biometric factors.

19. The system as claimed in claim 13, wherein the received user data is based on habitual pattern and behavioral aspects being recorded from daily life of the respective user.

20. The system as claimed in claim 13, wherein the user data comprises one or more of user bank account details; purchasing habit of the user; payment history; current GPS location of the user; user's commuting time to office and commuting route; contact details of friends, colleagues, relatives and acquaintances of the user; social interaction pattern of the user; community vouching; and user's biometric data.
